(19) United States
(12) Patent Application Publication
(10) Pub. No.: US 2023/0128201 A1
(43) Pub. Date: Apr. 27, 2023

(54) Common Mode Choke

(71) Applicant: Telefonaktiebolaget LM Ericsson (publ), Stockholm (SE)

(72) Inventor: Chong Zhao, BEIJING (CN)

(21) Appl. No.: 17/801,560

(22) PCT Filed: Feb. 28, 2020
(86) PCT No.: PCT/CN2020/077206

§ 371 Date: Aug. 23, 2022

(51) Int. Cl. H01F 17/04; H01F 27/29

(52) U.S. Cl. CPC H01F 17/043; H01F 27/292; H01F 2017/0093

(57) ABSTRACT

A common mode choke (200, 1100) comprises a core (240). The common mode choke (200, 1100) further comprises a first coil (221), a second coil (222), a third coil (223), and a fourth coil (224) wound around the core (240). The common mode choke (200, 1100) is operative to attenuate any common mode component of a pair of signals. A first signal of the pair of the signals passes through two of the first through fourth coils (221, 222, 223, 224) and a second signal of the pair of the signals passes through the other two of the first through fourth coils (221, 222, 223, 224), such that at least a part of the magnetic field created by the first signal has a direction identical to that of at least a part of the magnetic field created by the second signal.

### TECHNICAL FIELD

The present disclosure is related to the field of electronic component, and in particular, to a common mode choke.

### BACKGROUND

This section introduces aspects that may facilitate better understanding of the disclosure. Accordingly, the statements of this section are to be read in this light and are not to be understood as admissions about what is in the prior art or what is not in the prior art.

In electronics, a choke is typically an inductor used to block higher-frequency while passing direct current (DC) and lower-frequencies of alternating current (AC) in an electrical circuit. A choke usually consists of a coil of insulated wire often wound around a magnetic core, although some consist of a doughnut-shaped “bead” of ferrite material strung on a wire. The choke's impedance increases with frequency. Its low electrical resistance passes both AC and DC with little power loss, but its reactance limits the amount of AC passed.

A common-mode (CM) choke, where two coils are wound around a single core, is useful for suppression of electromagnetic interference (EMI) and radio frequency interference (RFI) from power supply lines and for prevention of malfunctioning of power electronics device. It passes differential currents (equal but opposite), while blocking common-mode currents. The magnetic flux produced by differential-mode (DM) currents in the core tend to cancel each other out since the windings are negative coupled. Thus, the choke presents little inductance or impedance to DM currents. The CM currents, however, see a high impedance because of the combined inductance of the positive coupled windings. CM chokes are commonly used in industrial, electrical and telecommunications applications to remove or decrease noise and related electromagnetic interference.

### SUMMARY

According to some embodiments of the present disclosure, a common mode choke is provided.

In some embodiments, a common mode choke comprises: a core; a first coil, a second coil, a third coil, and a fourth coil wound around the core, wherein the common mode choke is operative to attenuate any common mode component of a pair of signals, wherein a first signal of the pair of the signals passes through two of the first through fourth coils and a second signal of the pair of the signals passes through the other two of the first through fourth coils, such that at least a part of the magnetic field created by the first signal has a direction identical to that of at least a part of the magnetic field created by the second signal.

In some embodiments, at least a portion of the core has a shape of cylinder. In some embodiments, the portion of the core comprises two sub-portions, each of which having a shape of cylinder and being adjoined to each other by joining one's top surface of cylinder to the other's top surface of cylinder. In some embodiments, the two sub-portions are joined together in a mirror symmetric manner. In some embodiments, the two sub-portions are joined by epoxy adhesive. In some embodiments, there is an air gap between the two sub-portions of the core. In some embodiments, the air gap is in a range of 5 micrometers to 10 micrometers. In some embodiments, the portion of the core is integrally formed. In some embodiments, the core comprises two EP cores joined at end surfaces thereof by epoxy adhesive.

In some embodiments, the first through fourth coils are wound around the lateral surface of the portion of the core in a non-overlapping manner and in a sequential order. In some embodiments, the first through fourth coils are wound around the core in a same winding direction. In some embodiments, the first coil has a first end and a second end, and the second coil has a third end and a fourth end, the third end of the second coil being electrically connected to the second end of the first coil, wherein the third coil has a fifth end and a sixth end, and the fourth coil has a seventh end and an eighth end, the seventh end of the third coil being electrically connected to the sixth end of the third coil. In some embodiments, the first signal is input via the first end of the first coil and output via the fourth end of the second coil, while the second signal is input via the eighth end of the fourth coil and output via the fifth end of the third coil. In some embodiments, the first and second coils are wound around the core in a first winding direction, and the third and fourth coils are wound around the core in a second winding direction opposite to the first winding direction. In some embodiments, the first coil has a first end and a second end, and the second coil has a third end and a fourth end, the third end of the second coil being electrically connected to the second end of the first coil, wherein the third coil has a fifth end and a sixth end, and the fourth coil has a seventh end and an eighth end, the seventh end of the third coil being electrically connected to the sixth end of the third coil. In some embodiments, the first signal is input via the first end of the first coil and output via the fourth end of the second coil, while the second signal is input via the fifth end of the third coil and output via the eighth end of the third coil.

In some embodiments, the first through fourth coils are wound around the lateral surface of the portion of the core in a non-overlapping manner and in a sequential order. In some embodiments, the first through fourth coils are wound around the core in a same winding direction. In some embodiments, the first coil has a first end and a second end, and the second coil has a third end and a fourth end, the first end of the first coil being electrically connected to the third end of the second coil, and the second end of the first coil being electrically connected to the fourth end of the second coil, wherein the third coil has a fifth end and a sixth end, and the fourth coil has a seventh end and an eighth end, the fifth end of the third coil being electrically connected to the seventh end of the fourth coil, and the sixth end of the third coil being electrically connected to the eighth end of the fourth coil. In some embodiments, the first signal is input via the first end of the first coil and the third end of the second coil and output via the second end of the first coil and fourth end of the second coil respectively, while the second signal is input via the sixth end of the third coil and the eighth end of the fourth coil and output via the fifth end of the third coil and the seventh end of the fourth coil respectively.

In some embodiments, the common mode choke further comprises a switching circuit configured to enable the common mode choke to function in different modes by electrically connecting the first through fourth coils in different manners. In some embodiments, the electrical connections between the ends are achieved by wires or traces on a printed circuit board (PCB). In some embodiments, the number of turns of wire in each of the first through fourth coils is between 3.5 to 5.5. In some embodiments, the common mode choke has a dimension of 22.5 mm*32 mm*22.3 mm with a tolerance of ±0.5 mm. In some embodiments, each of the first through fourth coils is made of a flat wire. In some embodiments, each of the coils has its both ends function as one or more terminals for input and/or output. In some embodiments, each of the first through fourth coils is formed by a helical winding method.

In some embodiments, the core has a shape of torus, and the first through fourth coils are wound around the core in a non-overlapping manner and separated from each other. In some embodiments, one or more first capacitors are electrically connected between a first path along which the first signal passes and a second path along which the second signal passes, the first path comprising the first coil and the second coil and the second path comprising the third coil and the fourth coil. In some embodiments, each of the one or more first capacitors has one of the following configurations: its one terminal electrically connected to the first end of the first coil and its other terminal electrically connected to the fifth end of the third coil; its one terminal electrically connected to the second end of the first coil and its other terminal electrically connected to the sixth end of the third coil; or its one terminal electrically connected to the fourth end of the second coil and its other terminal electrically connected to the eighth end of the fourth coil. In some embodiments, one or more second capacitors are electrically connected between a first path along which the first signal passes and the ground, the first path comprising the first coil and the second coil; and/or wherein one or more second capacitors are electrically connected between a second path along which the second signal passes and the ground, the second path comprising the third coil and the fourth coil. In some embodiments, each of the one or more second capacitors has one of the following configurations: its one terminal electrically connected to the first end of the first coil and its other terminal electrically connected to the ground; its one terminal electrically connected to the second end of the first coil and its other terminal electrically connected to the ground; its one terminal electrically connected to the fourth end of the second coil and its other terminal electrically connected to the ground; its one terminal electrically connected to the fifth end of the third coil and its other terminal electrically connected to the ground; its one terminal electrically connected to the sixth end of the third coil and its other terminal electrically connected to the ground; or its one terminal electrically connected to the eighth end of the fourth coil and its other terminal electrically connected to the ground. In some embodiments, one or more first capacitors are electrically connected between a first path along which the first signal passes and a second path along which the second signal passes; wherein one or more second capacitors are electrically connected between a first path along which the first signal passes and the ground, and/or one or more second capacitors are electrically connected between a second path along which the second signal passes and the ground, wherein the first path comprises the first coil and the second coil and the second path comprises the third coil and the fourth coil. In some embodiments, the one or more first capacitors and/or the one or more second capacitors are disposed on a different surface of a printed circuit board (PCB) than the surface of the PCB on which the common mode choke is disposed.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating the operation principle of an exemplary common mode choke in the related art.

FIG. 2 is a perspective view of an exemplary common mode choke according to an embodiment of the present disclosure.

FIG. 3 shows (a) a top view, (b) a side view, and (c) a bottom view of an exemplary common mode choke according to an embodiment of the present disclosure.

FIG. 4A and FIG. 4B are partially exploded perspective views of an exemplary common mode choke according to an embodiment of the present disclosure.

FIG. 5 shows (a) a perspective view, (b) a bottom view, and (c) a side view of a half of a magnetic core of an exemplary common mode choke according to an embodiment of the present disclosure.

FIG. 6A is a diagram illustrating a configuration of an exemplary common mode choke according to an embodiment of the present disclosure.

FIG. 6B is a schematic diagram illustrating an equivalent circuit of the exemplary common mode choke shown in FIG. 6A.

FIG. 7 is a diagram illustrating an exemplary printed circuit board (PCB) layout of a PCB on which an exemplary common mode choke according to an embodiment of the present disclosure could be mounted.

FIG. 8 is a diagram illustrating another configuration of an exemplary common mode choke according to another embodiment of the present disclosure.

FIG. 9 is a diagram illustrating yet another configuration of an exemplary common mode choke according to yet another embodiment of the present disclosure.

FIG. 10 is a diagram illustrating a further configuration of an exemplary common mode choke according to a further embodiment of the present disclosure.

FIG. 11 is a diagram illustrating a yet further configuration of an exemplary common mode choke according to a yet further embodiment of the present disclosure.

FIG. 12 is a diagram illustrating an exemplary configuration of an EMC filter circuit comprising an exemplary common mode choke according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just means that there is an electrical or communicative connection between two elements and they can be connected either directly or indirectly, unless explicitly stated to the contrary.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

Of course, the present disclosure may be carried out in other specific ways than those herein set forth without departing from the scope and essential characteristics of the invention. One or more of the specific processes discussed below may be carried out in any communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the invention is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of Radio Frequency (RF) communication circuit, the present disclosure is not limited thereto.

Furthermore, relative terms, such as “lower”, “bottom”, “upper”, “top”, “left”, or “right,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Exemplary embodiments of the present disclosure are described herein with reference to cross-section illustrations that are schematic illustrations of idealized embodiments (and intermediate structures) of the present disclosure. As such, variations from the shapes of the illustrations as a result, for example, of manufacturing techniques and/or tolerances, may be expected. Thus, the disclosed example embodiments of the present disclosure should not be construed as limited to the particular shapes of regions illustrated herein unless expressly so defined herein, but are to include deviations in shapes that result, for example, from manufacturing. Thus, the regions illustrated in the figures are schematic in nature and their shapes are not intended to illustrate the actual shape of a region of a device and are not intended to limit the scope of the invention, unless expressly so defined herein.

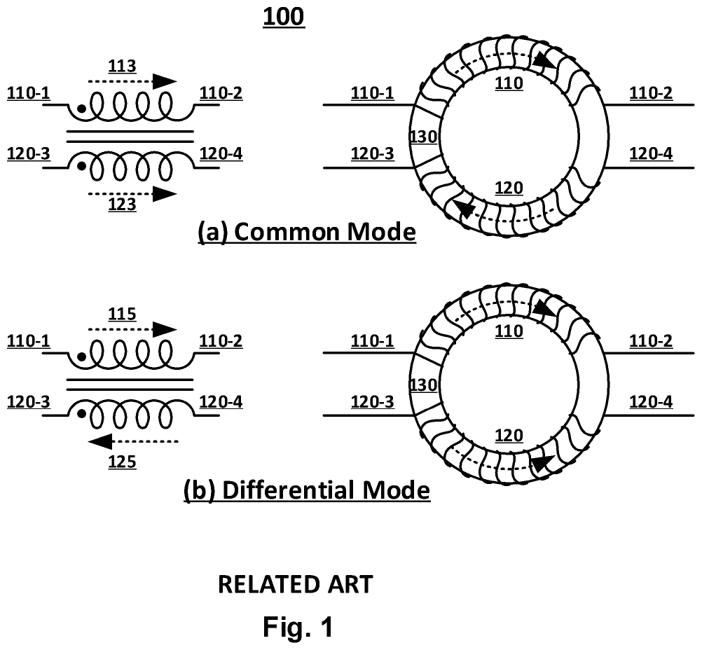

As mentioned above, a common mode choke may be used to suppress common mode components of a pair of signals with respect to the ground, such as noise. The description of the operation principle of a common mode choke will be given with reference to FIG. 1 below.

FIG. 1 is a diagram illustrating the operation principle of an exemplary common mode choke 100 in the related art. As shown in FIG. 1, the common mode choke 100 may comprise a magnetic core (or sometimes “core” hereinafter) 130 and two coils 110 and 120 which are wound around the core 130. The coil 110 has two ends 110-1 and 110-2, and the coil 120 also has two ends 120-3 and 120-4, for signal inputs and/or outputs. Further, the coil 110 may have a winding direction different from or same as that of the coil 120, depending on the definition of the ends or how the ends of the coils 110 and 120 are used.

As shown in (b) normal or differential mode of FIG. 1, signal current travels on one line in one direction from the source (e.g. the end 110-1) to the load (e.g. the end 110-2), and in the opposite direction (e.g. from the end 120-4 to the end 120-3) on the return line that completes the circuit. Further, as shown in (a) common mode of FIG. 1, a noise current travels on both lines in the same direction (e.g. from the end 110-1 to the end 110-2 and from the end 120-3 to the end 120-4).

As mentioned above, in the case of (a) common mode, the common mode components of the currents or signals, which may be caused by the noise common to the ground, may have a same travelling direction, shown by the reference numerals 113 and 123 at the top left corner of FIG. 1, respectively. In such a case, as shown at the top right corner of FIG. 1, the magnetic fields caused by these two common mode components 113 and 123 may have a same direction and therefore are added to each other to create an increased overall magnetic field which in turn opposes the common mode components 113 and 123, according to the Coiling Right Hand Rule. In other words, the common mode components of the signals 113 and 123 will be suppressed by the common mode choke 100.

On the contrary, in the case of (b) differential mode, the differential mode components of the signals, which may be the original differential signals we desired, may have different travelling directions, shown by the differential mode components 115 and 125 at the bottom left corner of FIG. 1, respectively. In such a case, as shown at the bottom right corner of FIG. 1, the magnetic fields caused by these two differential mode components 115 and 125 have opposite directions and therefore are offset or cancelled out by each other to create a decreased or even cancelled magnetic field which does not suppress the differential mode components 115 and 125. In other words, the differential mode components of the signals 115 and 125 will not be suppressed by the common mode choke 100.

Therefore, in the common mode, currents in a group of lines travel in a same direction such that the combined magnetic flux adds to create an opposing field to block the noise, as illustrated by (a) common mode in FIG. 1. In the differential mode, the currents travel in opposite directions and the flux subtracts or cancels out such that the field does not oppose the normal mode signal, as illustrated by (b) differential mode in FIG. 1.

However, in a typical RF communication circuit, such as one used for an LTE/LTE-A/NR enabled user equipment, two or more common mode chokes are typically required and they occupy a large portion of space in the RF communication circuit (e.g. larger than 1173 mm²). Further, when multiple common mode chokes are used in an RF communication circuit, sometimes they are expected to have consistent electrical characteristics. However, it is difficult to maintain such a consistency between different chokes due to many reasons, and it is also too expensive to set up multiple chokes in a same RF communication circuit. Furthermore, a conventional common mode choke may have a cold soldering problem due to its large volume.

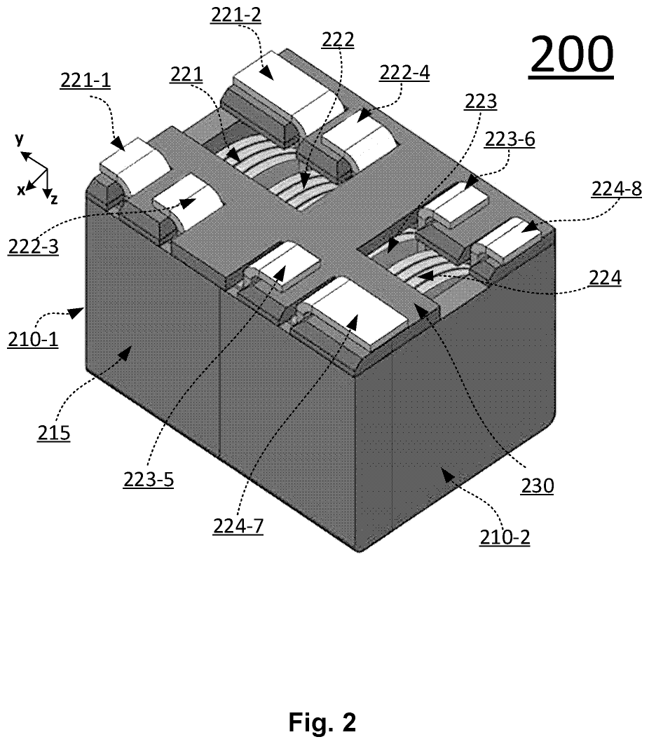

Therefore, to solve or at least partially alleviate the problems, a common mode choke according to some embodiments of the present disclosure is proposed. The description of the common mode choke will be given below with reference to FIG. 2 through FIG. 5.

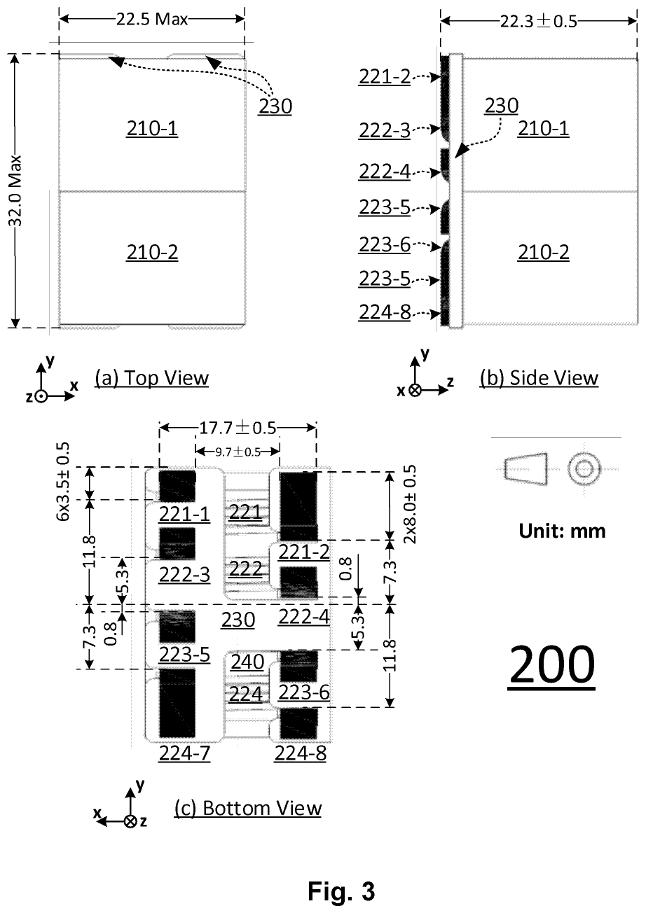

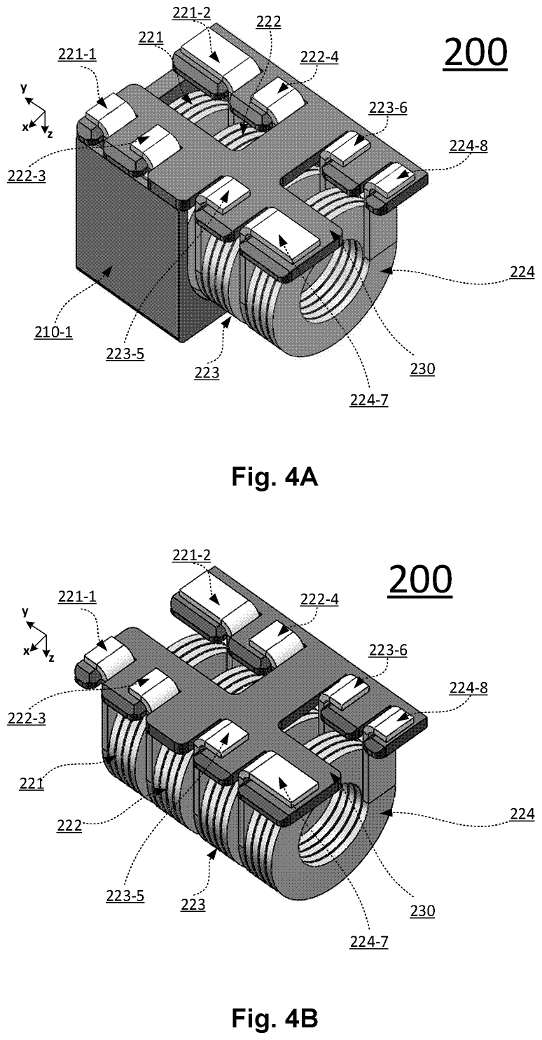

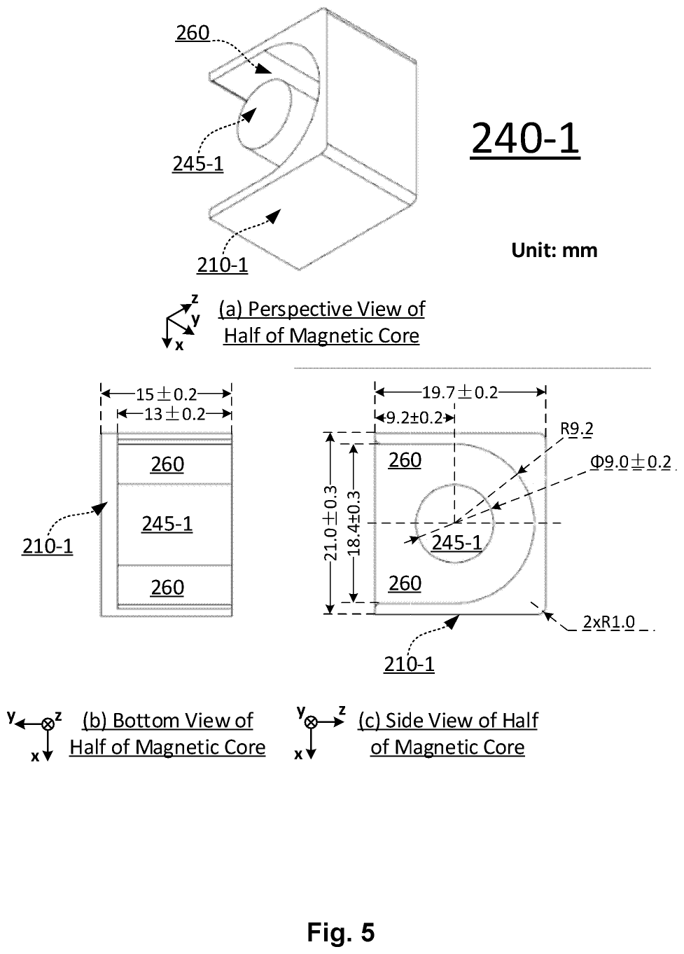

FIG. 2 through FIG. 5 show an exemplary common mode (CM) choke 200 according to an embodiment of the present disclosure. FIG. 2 is an upside-down perspective view of the CM choke 200. FIG. 3 shows (a) a top view, (b) a side view, and (c) a bottom view of the CM choke 200. FIG. 4A and FIG. 4B are partially exploded perspective views of the CM choke 200. FIG. 5 shows (a) a perspective view, (b) a bottom view, and (c) a side view of a half of a magnetic core of the CM choke 200. As shown in FIG. 2, the CM choke 200 may comprise a housing 210 (or 210-1 and 210-2), which is a part of a core 240 (or 240-1 and 240-2) as will be explained in details with reference to FIG. 5, and four coils comprising a first coil 221, a second coil 222, a third coil 223, and a fourth coil 224, and a bottom plate 230. Each of the first through fourth coils 221-224 may have two ends. That is, the first coil 221 has a first end 221-1 and a second end 221-2, the second coil 222 has a third end 222-3 and a fourth end 222-4, the third coil 223 has a fifth end 223-5 and a sixth end 223-6, and the fourth coil 224 has a seventh end 224-7 and an eighth end 224-8. Each of the ends may come out of a notch on the bottom plate 230 and serve as a pin or a contact of the CM choke 220 to be electrically connected to a RF communication circuit when the CM choke 200 is mounted on the RF communication circuit. Further, the locations and/or dimensions of the ends and/or the notches are not limited to those shown in FIG. 2-FIG. 5 and may be adapted based on practical needs or any other factors.

Further, as shown in FIG. 2, the housing 210 may be formed by joining two portions 210-1 and 210-2 together, for example, by an epoxy adhesive or by any other means. However, in some other embodiments, the housing 210 may be integrally formed or formed by more than two portions.

Further, although not seen in FIG. 2, the CM choke 200 may further comprise a core 240 (shown in FIG. 3 and FIG. 5) around which the first through the fourth coils 221-224 are wound. In other words, the four coils 221-224 share the same magnetic core 240.

Referring to FIG. 3, an exemplary configuration of the CM choke 200 is shown. As shown in FIG. 3, the CM choke 20 may have dimensions of 22.5 mm (w)*32 mm (I)*22.3 mm (h). When compared with existing CM chokes, the space occupied by the CM choke 200 is only 61% of that of two existing common mode chokes with totally four coils and similar overall electrical characteristics. Further, the volume of the CM choke 200 is only 57% of two existing common mode chokes with totally four coils and similar overall electrical characteristics. However, please note that any numerical values shown in the figures and/or given in the description are used for illustrative purpose only, and the present disclosure is not limited thereto.

As shown in (a) top view of FIG. 3, the bottom plate 230 may be slightly larger than the housing 210 at the corners and can be seen in the top view of the CM choke 200. However, in other embodiments, a different configuration of the bottom plate 230 may be used. For example, the bottom plate 230 may be completely hidden by the housing 210, and not be seen in the top view.

Referring to (b) slide view of FIG. 3, the left side wall of the housing 210 is shown and the ends of the first through fourth coils 221-224 are lead out through the bottom plate 230, and can be seen in the left side view of the CM choke 200. With reference to FIG. 2, FIG. 3, FIG. 4A, and FIG. 4B, each of the ends 221-1, 221-2, 222-3, 222-4, 223-5, 223-6, 224-7, and 224-8 may be an integral part of a respective one of the first through fourth coils 221-224. However, in some other embodiments, the ends 221-1, 221-2, 222-3, 222-4, 223-5, 223-6, 224-7, and 224-8 may be separately formed and then joined with the coils 221-224, respectively.

Referring to (c) bottom view of FIG. 3, the first through fourth coils 221-224 are wound around the core 240 in a non-overlapping manner and in a sequential order. In other words, any one of the first through fourth coils 221-224 is not interleaved with another of the first through fourth coils 221-224. Further, as mentioned above, the locations and/or dimensions of the ends and/or the notches are not limited to those shown in FIG. 2-FIG. 5 and may be adapted based on practical needs or any other factors.

FIG. 4A is an upside-down perspective view illustrating the CM choke 200 with a half of the magnetic core 240-2 comprising a half of the housing 210-2 removed, and FIG. 4B is an upside-down perspective view illustrating the CM choke 200 with the other half of the magnetic core 240-1 comprising the other half of the housing 210-1 further removed. As shown in FIG. 4A and FIG. 4B, each of the coils 221-224 may be formed by 4.5 turns of flat wire. However, the present disclosure is not limited thereto. In some other embodiments, each of the coils may be formed by a round wire, a flat wire, a hollow wire, or any combination thereof, and may be made of copper, aluminum, alloy, or any combination thereof. Further, in some other embodiments, each of the coils 221-224 may have a number of turns other than 4.5, for example, any value between 3.5 and 5.5 or any other suitable value. In some embodiments, each of the coils 221-224 may be made of 4.5 turns of SFT-AIW 220° C. flat copper wire. Further, each of the coils 221-224 may be formed by the helical winding method, but the present disclosure is not limited thereto.

As shown in FIG. 4A and FIG. 4B, each of the ends 221-1, 221-2, 222-3, 222-4, 223-5, 223-6, 224-7, and 224-8 may be formed by peeling off the insulation layer at the ends of the respective coils 221-224 and coating a layer of tin at the ends, such that the ends 221-1, 221-2, 222-3, 222-4, 223-5, 223-6, 224-7, and 224-8 may serve as pins or contacts for electrically connecting to other elements.

Further, as clearly shown in FIG. 4B, the winding directions of the first through fourth coils 221-224 are identical to each other. However, the present disclosure is not limited thereto. For example, even if the winding directions of some of the first through fourth coils 221-224 are different from the winding directions of rest of the first through fourth coils 221-224, the same or similar technical effect may be achieved by electrically connecting the ends of the coils in a different manner or supplying the ends with signals with a different direction.

FIG. 5 shows (a) perspective view, (b) bottom view, and (c) side view of a half of the magnetic core 240-1 comprising a half of the housing 210-1. As shown in FIG. 5, the half core 240-1 may be an EP core, a central portion 245-1 of which having a shape of cylinder around which some of the coils 221-224 are wound (e.g. the first coil 221 and the second coil 222). However, the present disclosure is not limited thereto. In some other embodiments, the half core 240-1 may have a different shape. For example, the half core 240-1 may be any of I-shaped core, C-shaped core, U-shaped core, E-shaped core, EFD core, ETD core, EP core, EI core, EE core, planar core, pot core, toroidal core, ring, and bead, or the like. Further, it is shown in FIG. 5 that the central portion 245-1 and the half housing 210-1 are formed integrally. However, in some other embodiments, the central portion 245-1 and the half housing 210-1 may be formed separately, and the central portion 245-1 per se functions as a cylinder core while the half housing 210-1 functions as a protection layer. In some embodiments, at least a portion of the core 240 may have a shape of cylinder. In some embodiments, the core 240 may be made of R10K material.

Further, as shown in FIG. 5, there is space between the inner surface 260 of the half housing 210-1 and the central portion 245-1 to accommodate some of the coils 221-224.

Referring back to FIG. 2, please note that the very side wall indicated by the reference numeral 210-2 may have a symmetric counterpart side wall of the housing 210-1 indicated by the reference numeral 210-1 in (b) bottom view of FIG. 5, which cannot be seen in FIG. 2, FIG. 4A, or (a) perspective view of FIG. 5. Further, as mentioned above, the locations and/or dimensions of the ends and/or the notches are not limited to those shown in FIG. 2-FIG. 5 and may be adapted based on practical needs or any other factors.

FIG. 2 through FIG. 5 show a specific configuration of the CM choke 200 in which the core 240 are actually made of two sub-cores which are joined to each other, for example, by an epoxy adhesive. A shown in FIG. 5, each of the sub-portions may have a shape of cylinder and adjoined to each other by joining one's top surface of cylinder to the other's top surface of cylinder. Further, the two sub-portions may be joined together in a mirror symmetric manner. However, the present disclosure is not limited thereto.

Further, when the two sub-portions are adjoined together, there may be an inartificial air gap between the two sub-portions, and the air gap may be in a range of 5 micrometers to 10 micrometers. The effect of the air gap in the CM choke 200 is to reduce the permeability and to make the coil's characteristics less dependent upon the initial permeability of the core material. For a common mode choke, the flux generated by two windings will cancel out, while for other applications, a gap will prevent saturation with large AC signals or DC bias and allow tighter control of inductance. However, the present disclosure is not limited thereto. In some other embodiments, the core 240 may be formed integrally, and there is no air gap in the core 240, and therefore different coil characteristics may be achieved.

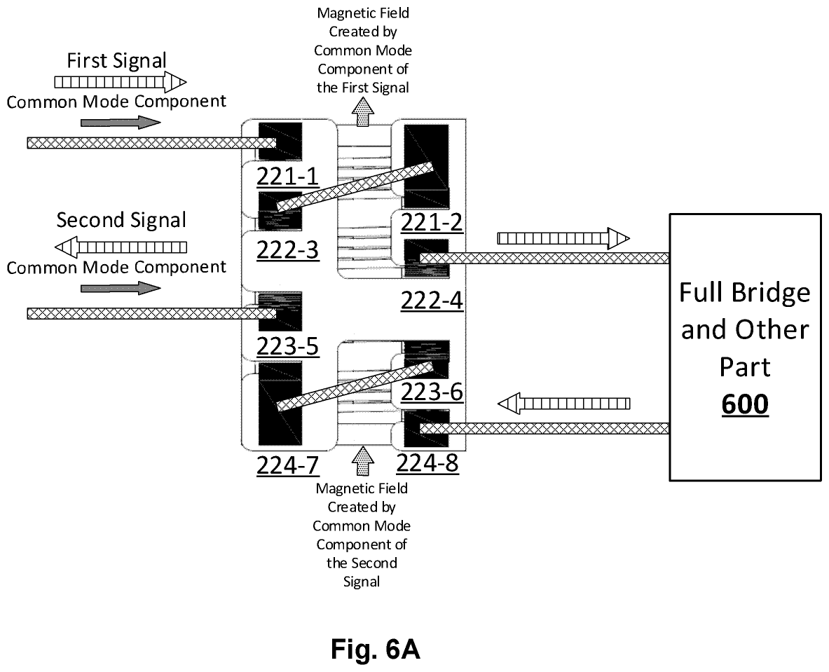

Next, the description of how to use the CM choke 200 will be given with reference to FIG. 6A-FIG. 12.

FIG. 6A is a diagram illustrating a configuration of an exemplary common mode choke 200 according to an embodiment of the present disclosure. As shown in FIG. 6A, the CM choke 200 may be fed with a pair of signals, i.e. a first signal and a second signal in which there are common mode components as shown by the arrows on the left side of FIG. 6A. The ends of the CM choke 200 are electrically connected such that: the first signal is input at the end 221-1 to the CM choke 200 and output at the end 222-4 to other part 600 of the RF communication circuit through the first coil 221 and the second coil 222, while the second signal is input at the end 224-8 from the other part 600 and output at the end 223-5 through the fourth coil 224 and the third coil 223. In other words, the end 221-2 is electrically connected to the end 222-3, and the end 223-6 is electrically connected to the end 224-7. These electrical connections could be achieved by wires or traces on a PCB on which the CM choke 200 is mounted in some embodiments.

In this way, when the first signal and the second signal pass through the CM choke 200, their common mode components, which may be caused by noise or interference, may have a same travelling direction while the pair of the signals per se have different travelling directions.

As shown in FIG. 6A, when the common mode component of the first signal is input at the end 221-1 to the CM choke 200, the common mode component passes through the first coil 221 and the second coil 222 and creates a magnetic field indicated by the arrow above the coils in FIG. 6A, according to the Coiling Right Hand Rule. On the other hand, when the common mode component of the second signal is input at the end 224-8 to the CM choke 200, the common mode component passes through the fourth coil 224 and the third coil 223 and creates a magnetic field indicated by the arrow under the coils in FIG. 6A, according to the Coiling Right Hand Rule. Therefore, the magnetic field created by the common mode component on the first and second coils has an identical direction to that created by the common mode component on the third and fourth coils, and they will be added to each other to create an even stronger magnetic field which suppresses the common mode components of the signals.

By contrast, the differential mode components of the signals may create magnetic fields with different directions on the coils, as explained earlier with reference to FIG. 1, and therefore the magnetic fields are cancelled out by each other and the signals per se are not suppressed.

FIG. 6B is a schematic diagram illustrating an equivalent circuit of the exemplary common mode choke 200 shown in FIG. 6A. As shown in FIG. 6B, the end 221-2 is electrically connected to the end 222-3 while the end 223-6 is electrically connected to the end 224-7. In the context of the equivalent circuit, the CM choke 200 may be referred to as a two-stage common mode choke.

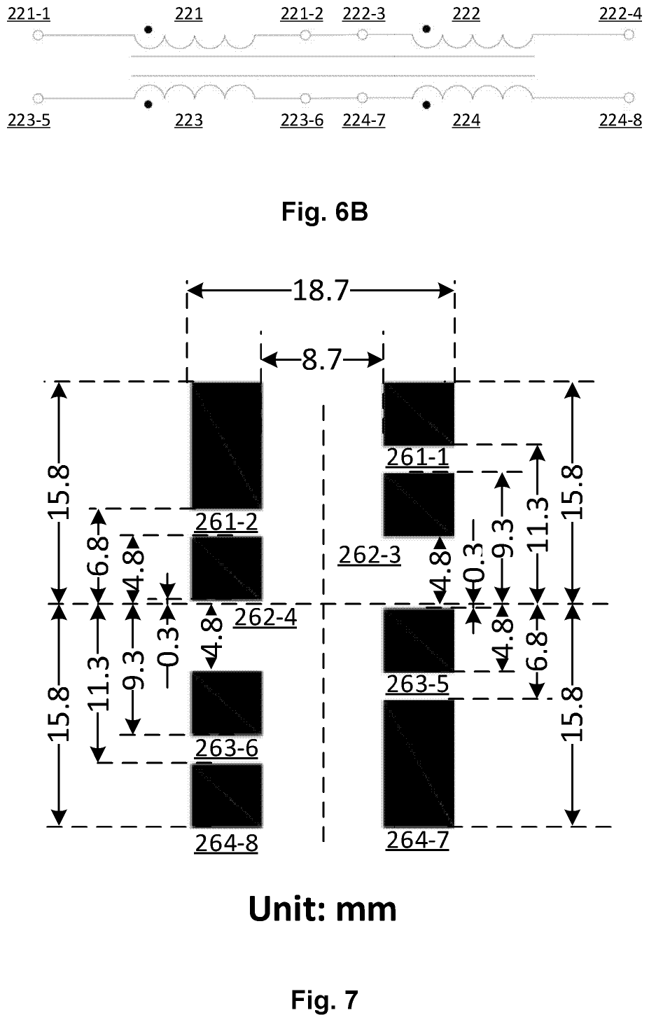

FIG. 7 is a diagram illustrating an exemplary printed circuit board (PCB) layout of a PCB on which an exemplary common mode choke (e.g. the CM choke 200 shown in FIG. 2) according to an embodiment of the present disclosure could be mounted. Further, as mentioned above, the locations and/or dimensions of the ends and/or the notches are not limited to those shown in FIG. 2-FIG. 5 and may be adapted based on practical needs or any other factors. Therefore, the PCB layout may also be adapted accordingly. With this PCB layout, a more complex circuit (such as an RF communication circuit) comprising the CM choke 200 may be implemented. Further, the locations and/or dimensions of the pads or contacts are not limited to those shown in FIG. 7 and may be adapted based on practical needs or any other factors.

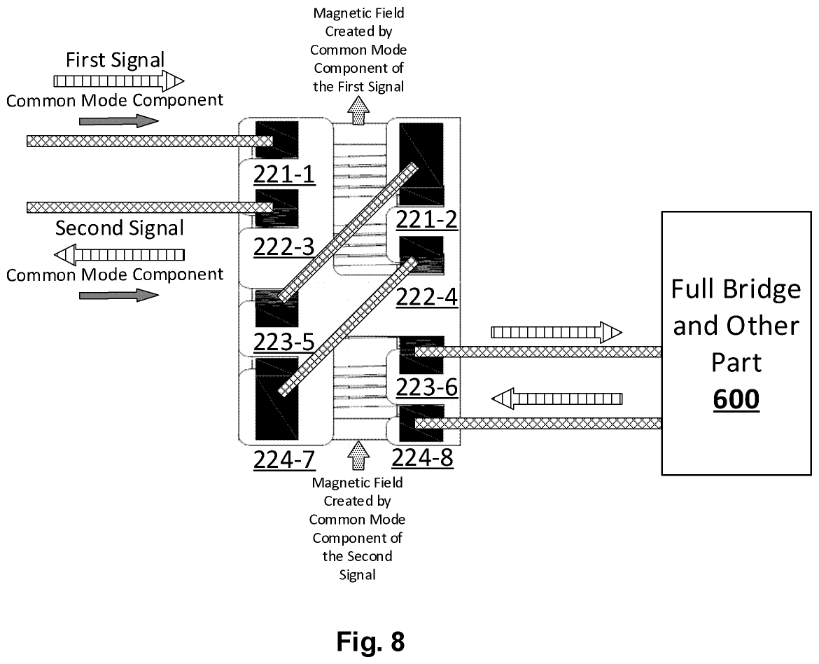

FIG. 8 is a diagram illustrating another configuration of an exemplary common mode choke according to another embodiment of the present disclosure. The embodiment shown in FIG. 8 differs from that of FIG. 6A in that the ends are electrically connected in a different manner and some of the ends may serve for different purposes while the rest remains the same. To be specific, the end 221-2 is electrically connected to the end 223-5 instead of the end 222-3, and the end 224-7 is electrically connected to the end 222-4 instead of the end 223-6. Further, the first signal is output to the other part 600 via the end 223-6 instead of the end 222-4, and the second signal is output via the end 222-3 instead of 223-5. In this way, the function of the second coil 222 and the function of the third coil 223 are swapped with each other. Therefore, the operation principle of the CM choke shown in FIG. 8 is similar to that shown in FIG. 6A, and the detailed description thereof is omitted for simplicity.

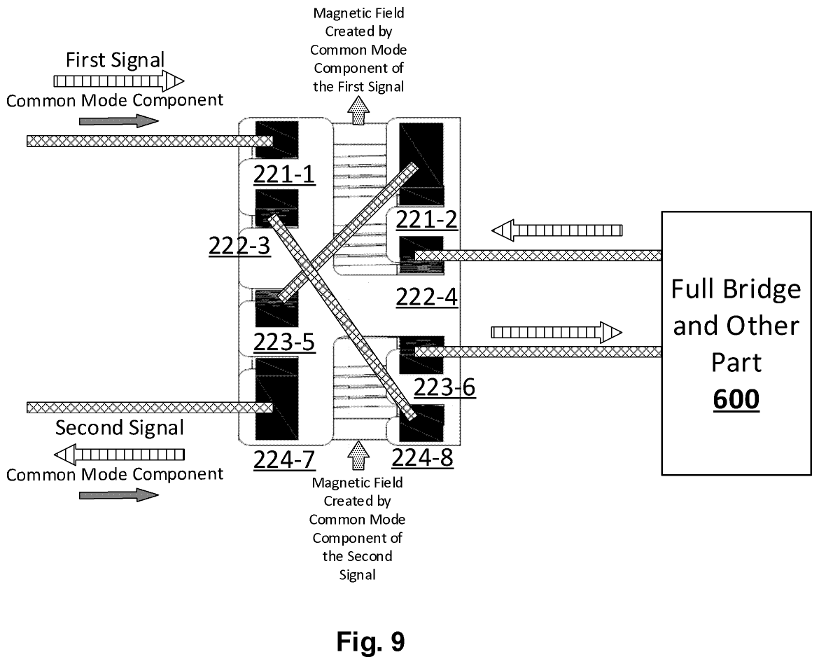

FIG. 9 is a diagram illustrating yet another configuration of an exemplary common mode choke according to yet another embodiment of the present disclosure. The embodiment shown in FIG. 9 differs from that of FIG. 8 in that the ends are electrically connected in a further different manner and some of the ends may serve for further different purposes while the rest remains the same. To be specific, the second signal is output at the end 224-7 instead of the end 222-3 and input at the end 222-4 instead of 224-8. Further, the end 224-8 is electrically connected to the end 222-3 while the end 222-4 is not electrically connected to the end 224-7 any longer. In this way, the function of the second coil 222 and the function of the fourth coil 224 are swapped with each other. Therefore, the operation principle of the CM choke shown in FIG. 9 is similar to that shown in FIG. 8, and the detailed description thereof is omitted for simplicity.

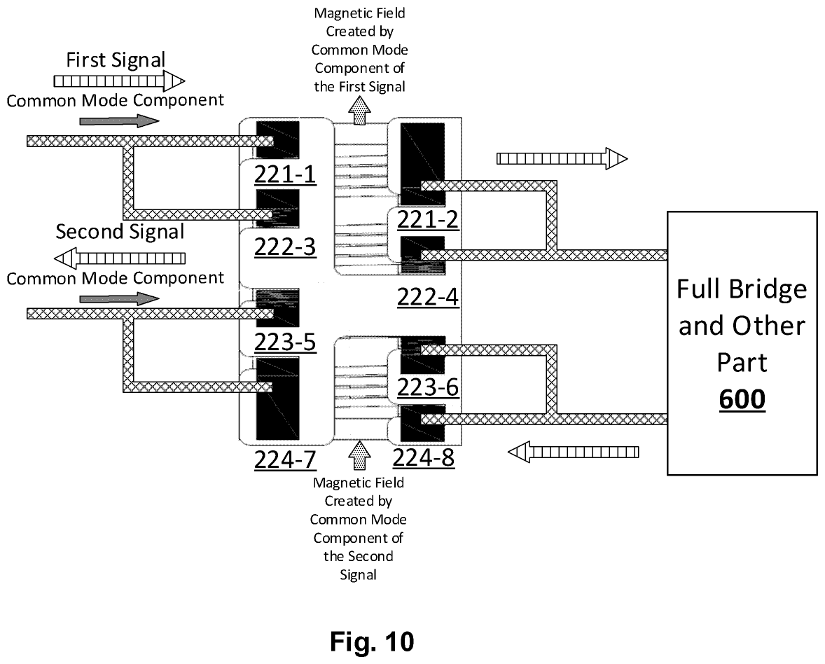

FIG. 10 is a diagram illustrating a further configuration of an exemplary common mode choke according to a further embodiment of the present disclosure. The embodiment shown in FIG. 10 differs from those of FIG. 8 and FIG. 9 in that the ends are electrically connected in a further different manner and some of the ends may serve for further different purposes while the rest remains the same. To be specific, the first signal is input at the end 222-3 in addition to the end 221-1, and the second signal is input at the end 224-6 in addition to the end 224-8. Further, the first signal is output at the end 221-2 in addition to the end 222-4, and the second signal is output at the end 224-7 in addition to the end 224-5. Further, there is no internal connection between the ends. In this way, the first coil 221 and the second coil 222 may be considered as a single coil with a higher current capacity and a less generated flux in the common mode. Therefore, the operation principle of the CM choke shown in FIG. 10 is more like a single common mode choke than the two stage common mode choke shown in FIGS. 8 and 9. However, the general operation principle is roughly similar and the detailed description thereof is omitted for simplicity.

With the embodiments of FIG. 6A, FIG. 8, FIG. 9, FIG. 10, it is clear that there may be many alternatives of the solutions already described and shown as long as similar functions are implemented. In fact, three factors may be considered when the CM mode choke 200 is used: the winding directions of the coils, the signal directions, and the definitions of the ends (i.e., inputs, outputs, or internal connections). In other words, although only some of the alternatives are shown and described in the present disclosure, one skilled in the art could design another CM choke 200 with a similar configuration considering the above three factors, which still falls into the scope of the present disclosure.

Further, a switching circuit or unit may be provided internally or externally to the CM choke 200 to enable the common mode choke 200 to function in different modes by electrically connecting the first through fourth coils 221-224 in different manners. That is, if the switching circuit is provided internally, then the CM choke 200 may be operated in different modes (e.g., those shown in FIG. 6A, FIG. 8, FIG. 9, or FIG. 10) by the switching unit. In other words, the CM choke 200 could be a multi-functional common mode choke 200. In some other embodiments, the switching circuit may be provided externally, for example, on the PCB on which the CM choke 200 is mounted.

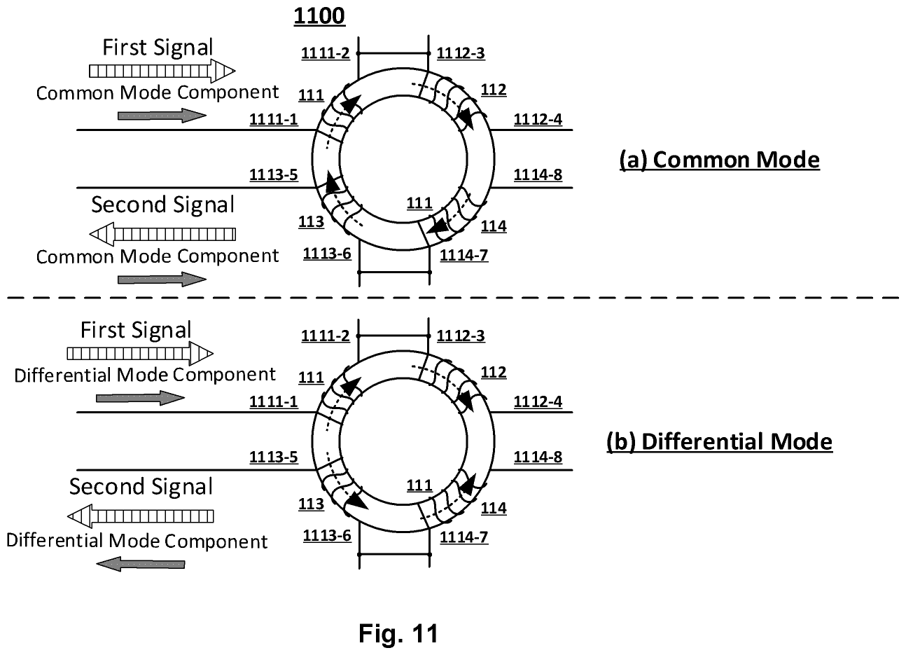

FIG. 11 is a diagram illustrating a yet further configuration of an exemplary common mode choke 1100 according to a yet further embodiment of the present disclosure. The CM choke 1100 is, to some extent, a combination of the CM choke 100 and the CM choke 200 in that its core has a shape of toroid similar to the CM choke 100 while the four coils are wound around the core and some of their ends are electrically connected similar to the CM choke 200.

As shown in (a) common mode of FIG. 11, when the common mode components of the signals are input at the end 1111-1 and 1113-5, respectively, they create magnetic fields with the same direction indicated by the arrows, and the magnetic fields are added to create an even stronger magnetic field which suppresses the common mode components of the signals. As shown in (b) differential mode of FIG. 11, when the differential mode components of the signals are input at the end 1111-1 and 1114-8, respectively, they create magnetic fields with the different directions indicated by the arrows, and the magnetic fields are offset and therefore the signals are not attenuated.

However, due to the shape/dimensions of the core of the CM choke 1100, different filter characteristics is achieved, and therefore it may be used in other scenarios than those for the CM choke 200.

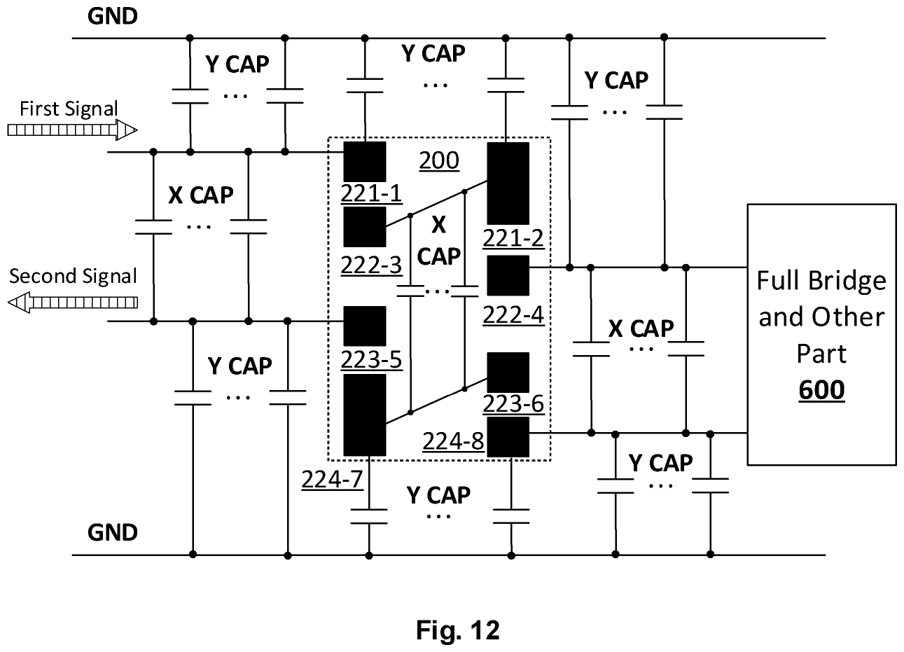

FIG. 12 is a diagram illustrating an exemplary configuration of an EMC filter circuit comprising an exemplary common mode choke 200 according to an embodiment of the present disclosure. The EMC filter circuit shown in FIG. 12 is designed to meet various safety regulations. Many safety regulations mandate that Class X (or “first capacitor” hereinafter) or Class Y capacitors (or “second capacitor” hereinafter) must be used whenever a “fail-to-short-circuit” could put humans in danger, to guarantee galvanic isolation even when the capacitor fails. Lightning strikes and other sources cause high voltage surges in mains power. Safety capacitors protect humans and devices from high voltage surges by shunting the surge energy to ground. In particular, safety regulations mandate a particular arrangement of Class X and Class Y mains filtering capacitors. In principle, any dielectric could be used to build Class X and Class Y capacitors; perhaps by including an internal fuse to improve safety. In practice, capacitors that meet Class X and Class Y specifications are typically ceramic RFI/EMI suppression capacitors or plastic film RFI/EMI suppression capacitors.

In addition to meeting the safety regulations, Class X capacitors may be used together with a common mode choke (e.g. the CM choke 200 or 1100) to filter out the differential mode noise, while Class Y capacitors may be used together with a common mode choke (e.g. the CM choke 200 or 1100) to filter out the common mode noise.

As shown in FIG. 12, one or more first capacitors (X CAPs) may be electrically connected between a first path along which the first signal passes and a second path along which the second signal passes, the first path comprising the first coil 221 and the second coil 222 and the second path comprising the third coil 223 and the fourth coil 224. In some embodiments, each of the one or more first capacitors may have one of the following configurations: its one terminal electrically connected to the end 221-1 and its other terminal electrically connected to the end 223-5, its one terminal electrically connected to the end 221-2 (or equivalently the end 222-3) and its other terminal electrically connected to the end 223-6 (or equivalently the end 224-7), or its one terminal electrically connected to the end 222-4 and its other terminal electrically connected to the end 224-8.

As also shown in FIG. 12, one or more second capacitors (Y CAPs) may be electrically connected between the first path along which the first signal passes and the ground (GND), the first path comprising the first coil 221 and the second coil 222. Alternatively or additionally, one or more second capacitors may be electrically connected between a second path along which the second signal passes and the ground, the second path comprising the third coil 223 and the fourth coil 224. In some embodiments, each of the one or more second capacitors may have one of the following configurations: its one terminal electrically connected to the end 221-1 and its other terminal electrically connected to the ground, its one terminal electrically connected to the end 221-2 (or equivalently the end 222-3) and its other terminal electrically connected to the ground, its one terminal electrically connected to the end 222-4 and its other terminal electrically connected to the ground, its one terminal electrically connected to the end 223-5 and its other terminal electrically connected to the ground, its one terminal electrically connected to the end 223-6 (or equivalently the end 224-7) and its other terminal electrically connected to the ground, or its one terminal electrically connected to the end 224-8 and its other terminal electrically connected to the ground.

Further, in some embodiments, the one or more first capacitors and the one or more second capacitors may be present at the same time based on the requirement of the safety or design. Furthermore, the capacitances of the first and/or second capacitors may be determined based on the requirement of the safety or design.

In some embodiments, the one or more first capacitors and/or the one or more second capacitors may be disposed on a different surface of a printed circuit board (PCB) than the surface of the PCB on which the common mode choke is disposed. In this way, the dimensions of the PCB and thus the final product may be reduced.

With the first and/or second capacitors, an EMC filter may be formed by the CM choke 200.

With the description of the CM chokes according to some embodiments of the present disclosure given above, it can be seen that the CM chokes according to the embodiments of the present disclosure occupy less space than the existing CM choke while providing a same or even better electrical characteristics. Further, since four coils share a same magnetic core and a same housing/bottom plate in the CM choke according to some embodiments of the present disclosure, a machining cost comprised in the production cost may be reduced.

Further, in some cases, with the CM choke according to some embodiments of the present disclosure, the process for mounting the CM choke may be optimized. For example, cold soldering, which is required by current existing mounting process, may be avoided completely, and the cost may be further reduced. Furthermore, some other benefits brought by the design of the CM choke according to some embodiments of the present disclosure may comprise but not limited to (1) the management and logistic supply chain of components will become simple; (2) the DC resistance of the CM choke according to some embodiments of the present disclosure is much less when compared with an existing CM choke with a same or similar size, and therefore much more energy will be saved.

The disclosure has been described with reference to embodiments and drawings. It should be understood that various modifications, alternations and additions can be made by those skilled in the art without departing from the spirits and scope of the disclosure. Therefore, the scope of the disclosure is not limited to the above particular embodiments but only defined by the claims as attached and equivalents thereof.

1. A common mode choke, comprising:
a core;
a first coil, a second coil, a third coil, and a fourth coil wound around the core,
wherein the common mode choke is operative to attenuate any common mode component of a pair of signals,
wherein a first signal of the pair of the signals passes through two of the first through fourth coils and a second signal of the pair of the signals passes through the other two of the first through fourth coils, such that at least a part of the magnetic field created by the first signal has a direction identical to that of at least a part of the magnetic field created by the second signal.

2. The common mode choke according to claim 1, wherein at least a portion of the core has a shape of cylinder.

3. The common mode choke according to claim 2, wherein the portion of the core comprises two sub-portions, each of which having a shape of cylinder and being adjoined to each other by joining one's top surface of cylinder to the other's top surface of cylinder.

4. The common mode choke according to claim 3, wherein the two sub-portions are joined together in a mirror symmetric manner.

5. The common mode choke according to claim 3, wherein the two sub-portions are joined by epoxy adhesive.

6. The common mode choke according to claim 3, wherein there is an air gap between the two sub-portions of the core.

7. The common mode choke according to claim 6, wherein the air gap is in a range of 5 micrometers to 10 micrometers.

8. The common mode choke according to claim 2, wherein the portion of the core is integrally formed.

9. The common mode choke according to claim 2, wherein the core comprises two EP cores joined at end surfaces thereof by epoxy adhesive.

10. The common mode choke according to claim 2, wherein the first through fourth coils are wound around the lateral surface of the portion of the core in a non-overlapping manner and in a sequential order.

11. The common mode choke according to claim 10, wherein the first through fourth coils are wound around the core in a same winding direction.

12. The common mode choke according to claim 11, wherein the first coil has a first end and a second end, and the second coil has a third end and a fourth end, the third end of the second coil being electrically connected to the second end of the first coil,
wherein the third coil has a fifth end and a sixth end, and the fourth coil has a seventh end and an eighth end, the seventh end of the third coil being electrically connected to the sixth end of the third coil.

13. The common mode choke according to claim 12, wherein the first signal is input via the first end of the first coil and output via the fourth end of the second coil, while the second signal is input via the eighth end of the fourth coil and output via the fifth end of the third coil.

14. The common mode choke according to claim 10, wherein the first and second coils are wound around the core in a first winding direction, and the third and fourth coils are wound around the core in a second winding direction opposite to the first winding direction.

15. (canceled)

16. (canceled)

17. The common mode choke according to claim 11, wherein the first coil has a first end and a second end, and the second coil has a third end and a fourth end, the first end of the first coil being electrically connected to the third end of the second coil, and the second end of the first coil being electrically connected to the fourth end of the second coil,
wherein the third coil has a fifth end and a sixth end, and the fourth coil has a seventh end and an eighth end, the fifth end of the third coil being electrically connected to the seventh end of the fourth coil, and the sixth end of the third coil being electrically connected to the eighth end of the fourth coil.

18. The common mode choke according to claim 17, wherein the first signal is input via the first end of the first coil and the third end of the second coil and output via the second end of the first coil and fourth end of the second coil respectively, while the second signal is input via the sixth end of the third coil and the eighth end of the fourth coil and output via the fifth end of the third coil and the seventh end of the fourth coil respectively.

19. The common mode choke according to claim 10, further comprising a switching circuit configured to enable the common mode choke to function in different modes by electrically connecting the first through fourth coils in different manners.

20-23. (canceled)

24. The common mode choke according to claim 1, wherein each of the first through fourth coils has its both ends function as one or more terminals for input and/or output.

25. (canceled)

26. (canceled)

27. The common mode choke according to claim 13, wherein one or more first capacitors are electrically connected between a first path along which the first signal passes and a second path along which the second signal passes, the first path comprising the first coil and the second coil and the second path comprising the third coil and the fourth coil.

28.-31. (canceled)

32. The common mode choke according to claim 19, wherein the one or more first capacitors and/or the one or more second capacitors are disposed on a different surface of a printed circuit board (PCB) than the surface of the PCB on which the common mode choke is disposed.
